(19) United States
(12) Patent Application Publication
(10) Pub. No.: US 2023/0005051 A1
(43) Pub. Date: Jan. 5, 2023

(54) CONTEXT-BASED PERSONALIZATION OF USER INTERFACES

(71) Applicant: Target Brands, Inc., Minneapolis, MN (US)

(72) Inventors: ASWINKUMAR VG, Bangalore Urban (IN); VIJAYENDER KARNATY, Bangalore Urban (IN); MANOHAR SRIPADA, Bangalore Urban (IN); DILEEP KUMAR PATCHIGOLLA, Bangalore Urban (IN); VAIBHAV TANDON, Bangalore Urban (IN); GAYATHRI KUSHALAPPA, Shoreview, MN (US)

(21) Appl. No.: 17/363,785

(22) Filed: Jun. 30, 2021

(51) Int. Cl. G06Q 30/06; G06F 3/0484; G06F 3/0482

(52) U.S. Cl. CPC G06Q 30/0643; G06Q 30/0625; G06Q 30/0633; G06F 3/04845; G06F 3/0482

(57) ABSTRACT

The disclosed context-based personalization system personalizes enterprise applications. The disclosed application collects and stores user events and user affinity signals during user sessions. By analyzing the captured user events and user affinity signals, the disclosed system can predict the user's preferences and customize settings, selections and options associated with the enterprise application based on the user's preferences.

### BACKGROUND

Customers are increasingly looking to conduct economic transactions via online retailers. With the increased demand for conducting economic transactions online, almost all retailers now also include an online store. To remain competitive in the market, online retailers are looking for solutions to improve the user's experience and ultimately improve user engagement.

### SUMMARY

Embodiments of the disclosure are directed to providing a personalized online experience for users.

In a first aspect, a method of personalizing options on an enterprise application for a user is provided. The disclosed method comprises: receiving a plurality of user events associated with one or more user sessions, wherein each of the one or more user sessions includes a discrete period of time when the user is interfacing with the enterprise application; extracting user affinity signals from the plurality of user events; based on the plurality of user events and user affinity signals, predicting the user's preferences associated with one or more options associated with the enterprise application; personalizing the one or more options associated with the enterprise application to align with the user's preferences, including: reordering product listings such that one or more products including a feature that is predicted to be aligned with the user's preference is elevated to the top of the product listings, wherein the feature is one of: size, color, gender, brand, and type.

In a second aspect, a system for personalizing options on an enterprise application for a user is disclosed. The disclosed system comprises: a processor; memory storing instructions that when executed by the processor cause the system to: receive a plurality of user events associated with one or more user sessions, wherein each of the one or more user sessions includes a discrete period of time when the user is interfacing with the enterprise application; extract user affinity signals from the plurality of user events; based on the plurality of user events and user affinity signals, predict the user's preferences associated with one or more options associated with the enterprise application; personalize the one or more options associated with the enterprise application to align with the user's preferences, including: reorder search query auto-complete options such that a search query auto-complete option that is predicted to be aligned with the user's preference is elevated to the top of the search query auto-complete options.

In a third aspect, a method of personalizing an enterprise application for a user is disclosed. The disclosed method comprises: receiving a plurality of user events associated with one or more user sessions, wherein each of the one or more user sessions includes a discrete period of time when the user is interfacing with the enterprise application; extracting user affinity signals from the plurality of user events; based on the plurality of user events and user affinity signals, generating a user preference model that predicts the user's preferences regarding one or more options associated with the enterprise application; receiving one or more search query terms; presenting one or more search query completion options associated with the received one or more search query terms based on the generated user preference model; receiving a selection of a search query completion option from the on or more search query completion options; presenting one or more search result options associated with the selected search query completion option, wherein the presented search result options are re-ordered based on the user preference model and the presented search result options include one or more items; receiving a selection of an item from the one or more search result options; and presenting an item details user interface display associated with the enterprise application, wherein the item details user interface display includes one or more pre-populated user selectable options associated with the selected item.

### BRIEF DESCRIPTION OF DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example context-based personalization system that supports the context-based personalization of an application.

FIG. 2 illustrates an example configuration of the context-based personalization module.

FIG. 3 illustrates an example personalized user interface display associated with the enterprise webpage or application.

FIG. 4 illustrate another example personalized user interface display associated with the enterprise webpage or application.

FIG. 5 illustrates another example personalized user interface display associated with the enterprise webpage or application.

FIG. 6 illustrates another example personalized user interface display associated with the enterprise webpage or application.

FIG. 7 illustrates an example flowchart showing of an example set of steps executed by a context-based personalization module, according to an example embodiment.

FIG. 8 illustrates example physical components of the computing devices of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the subject matter of the present disclosure relates to providing a personalized online experience for users. One way to personalize the user's experience with an enterprise application includes gathering contextual information related to the user over multiple sessions and using the contextual information to provide auto-complete suggestions, search results, filter options, product listings, etc. that are personalized to the user's needs. Providing search result, product, and filter options that are personalized to the user's needs increases user engagement.

In some examples, the enterprise may include a retailer that is selling products or services online through a webpage or application. The enterprise application can include an online retailer's website or application with a user interface through which a user may be able to conduct economic transactions. However, the disclosed system and methods may be implemented for other types of enterprises and enterprise applications as well.

The disclosed context-based personalization system captures user affinity signals during user sessions. In some examples, a user session may include a period of time the user is interacting with the enterprise application. The user affinity signals are inferences made about the user and the user's preferences based on an analysis of the collected user events, including an analysis of the selections made by the user on the enterprise application in the same or previous sessions. The user affinity signals may include any selections that the user makes on the enterprise application that indicate the user's preference. In one example, user affinity signals include clothing sizes, shoes sizes, age, dietary preferences, type of product or service, brand preferences, price sensitivity, gifting preferences, fulfillment affinity, preferences for trends, store trip history, etc.

For example. user affinity signals are captured when the user is performing one or more events on the enterprise application. For example, events may include clicks, searches, adds to cart, purchases, browsing history, etc. An event handler may be used to capture and store all user events. In some examples, the captured user events may be analyzed and user affinity signals may be extracted from the user events.

In some examples, the captured user affinity signals may be used to discern the user context and elevate facets based on which facets the user engages with the most. For example, the captured user affinity signals are stored in association with the user's identifier and analyzed to predict user's interests and preferences. Based on the predictions, the auto-complete suggestions, search results, product listings, etc. may be tailored to the user's needs.

In one example, based on past orders and browsing patterns, the disclosed context-based personalization system may discern that the user wears (or at least has a browsing preference for) a size 7 shoe. The next time the user searches for “running shoes” on a search box within the enterprise application, the search result “running shoes size 7” may be elevated as the top result. In another example, based on previously captured user affinity signals, the products listing page following a search for “shoes” may include women's running shoes as the top results based on the captured affinity signals indicating that the user is a woman and typically only shops for running shoes. This may be the case despite the user not previously searching for running shoes of a particular size, but is instead based on previous browsing of dress shoes or other footwear having a size 7.

In addition to elevating product listing based on the captured user affinity signals, the disclosed context-based personalization system may also provide personalized filter options in addition to the generic filter options, wherein the personalized filter options include options based on the user's preferences from various categories. For example, typically, when the user searches for “shoes,” a search result page with a listing of products associated with the search term is displayed along with a panel of filter options for the user to select from to filter the search results. Typical filter options include size, color, gender, brand, price range, product type, etc. With the disclosed personalization application, an additional filter option may be provided that lists the user's usual preferences across various categories. For example, in addition to the usually available filter options, an additional filter option may be presented that lists: Size: 7, Color: Blue, Brand: Nike, Price: $100-$150. Having the user's preferred options across different categories listed together, and optionally grouped into a single convenient selectable filter, makes it easier for the user to make selection quickly and to be presented with relevant product listings quickly.

In some examples, the disclosed context-based personalization system is configured to receive and store guest events. The stored events may be analyzed, and user affinity signals may be extracted from the user events. In some examples, a data model may be used to predict the user's preferences across various categories based on the user affinity signals and stored data events. The predictions may be used to filter, re-order and personalize various user options on the enterprise application.

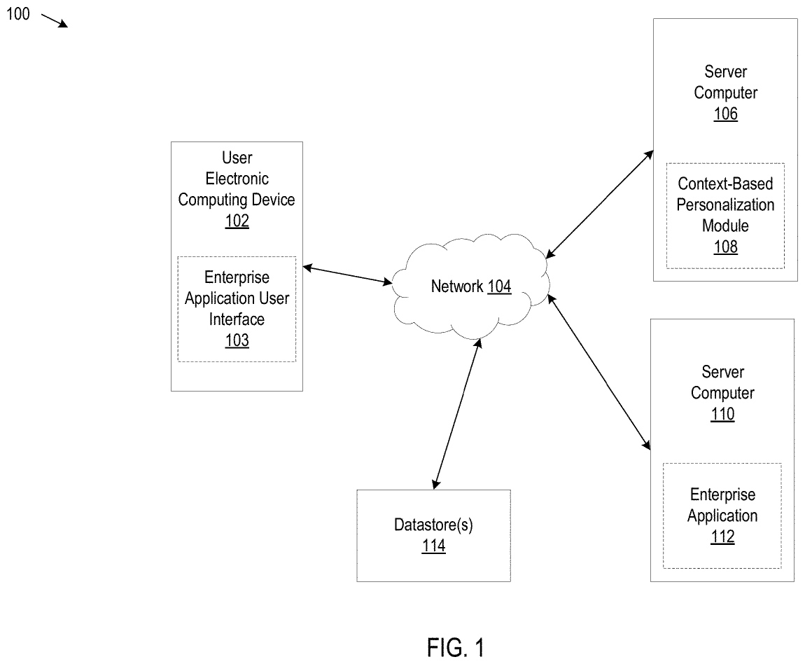

FIG. 1 illustrates an example context-based personalization system 100 that supports the context-based personalization of an application. The context-based personalization system 100 includes a user electronic computing device 102, a network 104, server computers 106, 110 and one or more datastores 114. In some examples, the server computer 106 may include a context-based personalization module 108 and the server computer 110 may include an enterprise application 112. In other examples, the context-based personalization module 108 and the enterprise application 112 may both be hosted by the same server computer of the enterprise. More, fewer or different modules can be used.

In some examples, user electronic computing device 102 is an electronic computing device of the user. In some examples, the electronic computing device can be a desktop computer, a laptop computer, a mobile electronic computing device such as a smartphone or a tablet computer. The electronic computing device permits the user to access the server computer 106 over a network 104. In some examples, the users of the electronic computing device may include users and customers of an enterprise that is configured to provide e-commerce services. Although a single user electronic computing device 102 is shown, the example context-based personalization system 100 may allow hundreds, thousands, or more computing devices to connect to the server computer 106.

In some examples, the user electronic computing device 102 may display an enterprise application user interface 103 using a display screen associated with the user electronic computing device 102. The enterprise application 112 (described below in detail) may be hosted by a server computer 110 and the user interface generated during the execution of the enterprise application 112 may be displayed on the user electronic computing device. For example, the enterprise application user interface 103 may interface with a user of the user electronic computing device 102 and receive inputs from the user and display information for the user.

In some examples, the network 104 is a computer network, such as the Internet. The user on user electronic computing device 102 can access the server computer 106 via the network 104.

In a preferred example, the server computers 106 and 110 are server computers of an enterprise or organization that is an online retailer of goods. However, the server computers 106, 110 may include server computers of other types of enterprises as well. Although a single server is shown, in reality, the server computers 106, 110 can be implemented with multiple computing devices, such as a server farm or through cloud computing. Many other configurations are possible.

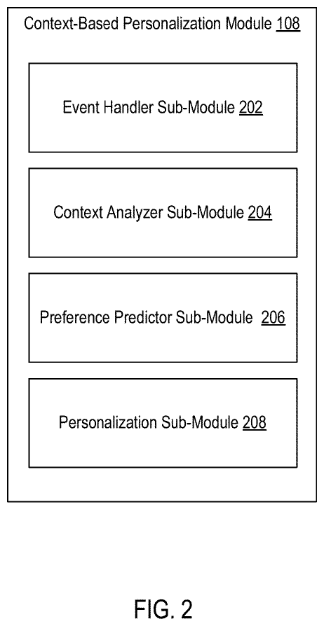

In one example, the context-based personalization module 108 collects and stores user events. As discussed in more detail later herein, the context-based personalization module 108 may analyze the collected user events to extract user affinity signals and based on the extracted user affinity signal and stored user events, use a machine learning data model to predict the user's preferences. The context-based personalization module 108 is configured to elevate search results, product listings or customize the filter options based on the data model's predictions regarding the user's preferences. The context-based personalization module 108 is described in further detail in relation to FIGS. 2-7.

In one example, the enterprise application 112 may include a website or mobile application associated with the enterprise that showcases the enterprises' products and services. The enterprise application 112 may be executed on the server computer 110. The execution of the enterprise application 112 may result in the generation and display of the enterprise application user interface 103 as described above. In a preferred example, the enterprise may be an online retailer of products and services and the enterprise application 112 may be a website or mobile application detailing the products and services for sale.

Although the context-based personalization module 108 and the enterprise application 112 are shown to be hosted by two separate server computers 106, 110 in the disclosed example from FIG. 1, the context-based personalization module 108 and the enterprise application 112 may be hosted by the same server computer of the enterprise or third-party associated with the enterprise.

The example datastore(s) 114 may include one or more electronic databases that can store one or more data tables that includes data associated with the enterprise. The context-based personalization module 108 may store and retrieve data in the datastore(s) 114 via the network 104. The datastore 114 may be maintained by the enterprise or organization itself or be maintained by one or more external, third-parties associated with the enterprise. The datastore 114 can be accessed by the server computer 106 to retrieve relevant data.

FIG. 2 illustrates an example configuration of the context-based personalization module 108. As detailed in relation to FIG. 1, the server computer 106 includes the context-based personalization module 108, which in turn may be implemented using one or more sub-modules.

In some examples, the disclosed context-based personalization module 108 may be configured to analyze user events, predict user preferences and ultimately customize the enterprise application 112 for each user. In some examples, the context-based personalization module 108 may include an event handler sub-module 202, a context analyzer sub-module 204, a preferences predictor sub-module 206 and a personalization sub-module 208. More or fewer sub-modules may be used to implement the context-based personalization module 108.

In some examples, the event handler sub-module 202 is configured to receive one or more user events. For example, a user may interface with an enterprise's webpage or application 112 in many ways. Each action the user performs in interfacing with the enterprise's webpage or application 112 may be considered a user event. For example, events may include clicks, swipes, toggles, typed texts, search query terms, selection of user options, adds to cart, products or services purchased, browsing pattern, etc. The example event handler sub-module 202 may receive the user events and process the events. The event handler sub-module 202 may further record the user events for further analysis.

In some examples, user events are stored in a datastore, such as datastore 114. The event handler sub-module 202 may associate the received events to the particular user's profile or identifier. The stored events may then be analyzed by the context analyzer sub-module 204 as described below. In some examples, a commercially available event handler application, such as Apache Kafka can be used to receive and process the user events.

In some examples, the context analyzer sub-module 204 is configured to receive user events from datastore 114 and analyze the data events to extract user affinity signals. For example, the user affinity signals may be extracted based on user events that may be collected over one session or several user sessions.

A user session may include a discrete period of time the user is interacting with the enterprise application 112. When a user interfaces with the enterprise's webpage or application 112 over multiple sessions, user events from each of the sessions are collected and stored in datastore 114 and associated with the user's profile or identifier. The example context analyzer sub-module 204 may the retrieve all or a subset of the stored user events for analysis and extraction of user affinity signals.

The user affinity signals may include any selections that the user makes on the enterprise application 112 that indicates information about the user as a person and/or the user's preference. In one example, user affinity signals include clothing sizes, shoe sizes, age, gender, dietary preferences, type of product, brand preferences, price sensitivity, gifting preferences, fulfillment affinity, preferences for trends, store trip history, delivery preferences, etc.

For example, a user event where the user has selected a size of 7 when purchasing a shoe may trigger the context analyzer sub-module 204 to extract and tag the user' size selection as a user affinity signal. The example context analyzer sub-module 204 may further organize the user affinity signals into a plurality of sub-categories, wherein each sub-category relates to a type of user affinity signal, such as size, price, etc.

In some examples, the preference predictor sub-module 206 may be configured to use a machine learning data model to use the extracted user affinity signals and the stored user events to identify and predict user preferences regarding one or more user options associated with the enterprise's webpage or application 112. For example, user options may include search terms, filter options, product listings, user selectable options associated with a product or purchase such as size, color, gender, delivery options, pickup options, etc. In some implementations, the preference predictor sub-module 206 may be configured to use a logistic regression data model in making the predictions. Other types of data models may also be used.

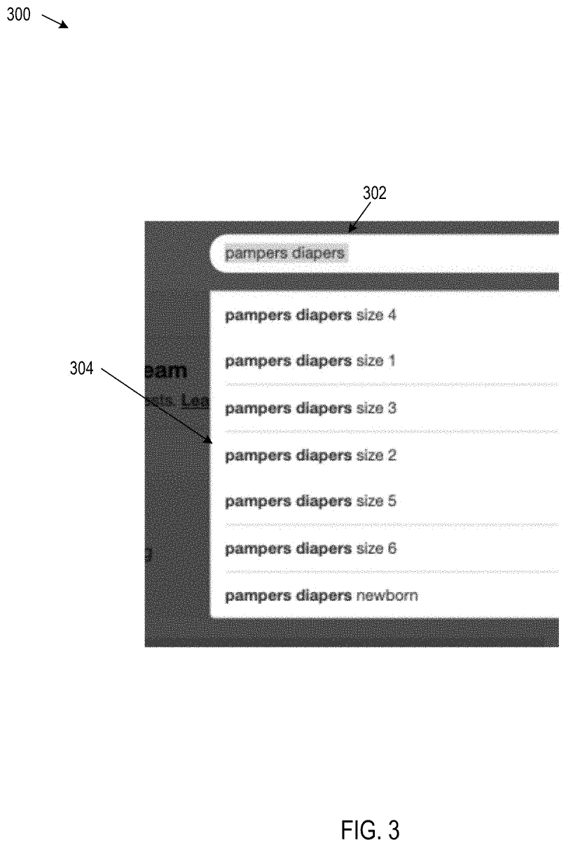

In some examples, the personalization sub-module 208 is configured to customize user options associated with the enterprise's webpage or application 112 based on the predictions made by the data model in the preference predictor sub-module 206. In one example, during search queries, the personalization sub-module 208 may elevate autocomplete search term options based on the user's predicted preferences. In another example, the personalization sub-module 208 may reorganize product listings based on the user's predicted preferences. In yet another example, the order of facets listed on product filters may be re-ordered based on the user's predicted preferences. In yet another example, new custom filter options that draws from multiple filter facets may be added to the product filter option. In yet another example, the user selectable options such as size, payment, delivery/pickup options may be auto-filled based on the user's predicted preferences. Some of these personalization configurations are described in further detail in relation to FIGS. 3-6.

FIG. 3 illustrates an example personalized user interface display 300 associated with the enterprise webpage or application 112. The example personalized user interface display 300 is configured to display personalized search query auto-complete options.

In some examples, the example use interface 300 includes a search box 302 that the user may use to type a query. When the user begins typing a search query, a listing of a plurality of auto-complete search query options 304 may be displayed adjacent to the search query box 304. The context-based personalization module, through the personalization sub-module 208 may re-order the plurality of auto-complete search query options 304 based on preference predictor sub-module's 206 predictions regarding the user's preferences.

In the disclosed example, when the user types in “pampers diapers” in the search query box 302, the plurality of auto-complete search query options 304 include: “pampers diapers size 4,” “pampers size diapers 1,” “pampers size diapers 3,” “pampers size diapers 2,” “pampers size diapers 5,” “pampers size diapers 6,” and “pampers diapers newborn.” Among the suggested plurality of auto-complete search query options, “pampers diapers size 4” is listed as the first option based on the preference predictor submodule's 206 prediction that the user is likely searching for a size 4 diaper.

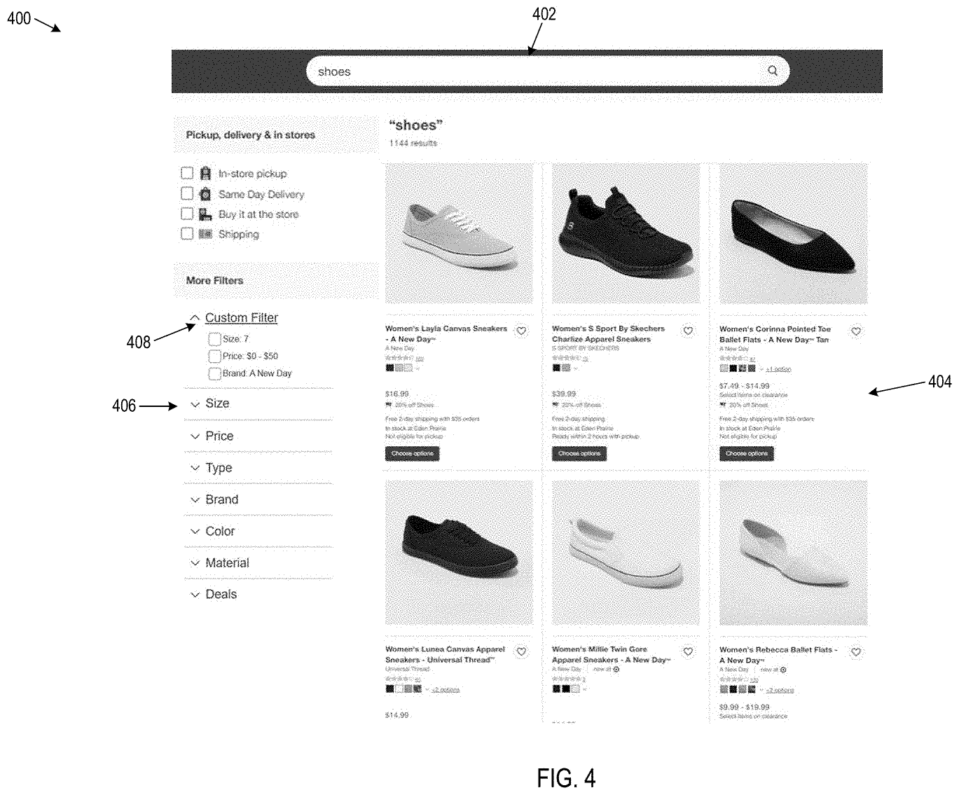

FIG. 4 illustrate another example personalized user interface display 400 associated with the enterprise webpage or application 112. The example personalized user interface display 400 is configured to display a personalized product listings page.

In the disclosed example from FIG. 4, the search query box 402 is configured to receive one or more search terms from the user. In response to one or more search terms entered in the in the search query box 402, a plurality of products that are relevant to the entered search terms may be listed in a product listings section 404 of the enterprise's user interface 400.

In the disclosed example, the search term “shoes” is entered in the search query box 402. In response to the entered search terms a grid of products are listed in the product listing section 404. In some examples the products may be listed in a grid within the products listing section 404. In other examples the products may organized differently. In some examples, each product listed within the product listing section includes a brief summary of information associated with the product itself. In the present example, each product within the product listing section 404 includes: an image associated with the product, the name of the product, a rating, color options associated with the product, price, any associated deals, shipping options. In other examples, more or fewer details regarding the product are included within the product listing section 404.

Typically, the listing of products within the product listing section 404 in response to a search term are based on the relevancy of the product to the search term and the overall popularity of the product among users in general. However, such a listing may not be particularly relevant to the specific user that is searching for the product.

For example, when a search is conducted for the term “shoes,” the results listed within product listing section may include men's running shoes because of the overall popularity of such shoes at the time of the search. However, if the particular user conducting the search is female and looking for heels, she may not find the product listings particularly relevant or helpful.

In the disclosed example, the preference predictor sub-module 206 of the context-based personalization system 100 may use previously collected and extracted user events and user affinity signals to predict that the instant user is female has a preference for shoes that are: women's shoes, flats, size 7, under $50, and from the brand, “A New Day.” In response, the personalization sub-module 208 may reorder the typical search results such that products more relevant to the particular to the user conducting the search are elevated to be higher within the product listings section 404.

For example, in the disclosed product listings section 404 from FIG. 4, the top six of the search results are listed in a grid layout. Even though the search term only specifies that the user is searching for “shoes,” because of the predictions made by the disclosed preference predictor sub-module 206 and the re-ordering made by the personalization sub-module 208, the top six results listed within the product listings section 404 includes only women's shoes that are flats (or shoes with no heels, such as ballet flats, sneakers, etc), under $50 and overwhelmingly from the user's favorite brand, “A New Day.”

In addition to the product listings section 404, the example personalized user interface also includes a filter options section 406. The filter options section 406 includes a plurality of filter facets such as: “Size,” “Price,” “Type,” “Brand,” “Color,” “Material,” and “Deals.” More or fewer filter facets may also be listed within the filter options section 406.

In addition to the universal filter facets described above, the personalization sub-module 208 may also cause a “custom filter” filter facet 408 to be included within the filter options section 406. The “custom filter” facet 408 may be configured to compile together and include one or more options from one or more filter facets that the particular user prefers, thus providing the particular user with all the relevant filter options under one filter facet, thus making the selection of filters easier and more efficient. For example, in the disclosed exampled from FIG. 4, the user's preferred selections, such as a shoe size of 7, a price of $0 to $50 and a brand preference of “A New Day,” which are typically listed under separate filter facets of “size,” “price,” and “brand, are compiled together and listed under one “custom filter” facet 408.

In some examples, the personalization sub-module 208 may cause the list of filter facets themselves to be re-ordered based on the predictions made by the preference predictor sub-module 206 regarding the user's preferences. For example, the filter facets that the user considers to be most important when filtering search results may be listed at the top, while filter facets that are considers to be less important when filtering search results may be listed towards the bottom of the filter options section 406. In the disclosed example, the filter options section 406 lists “custom filter,” “size” and “price” towards the top of the filter options section 406, and lists “material” and “deals” towards the bottom of the filter options section 406, indicating that the user typically filters search results based on size and price rather than material and deals.

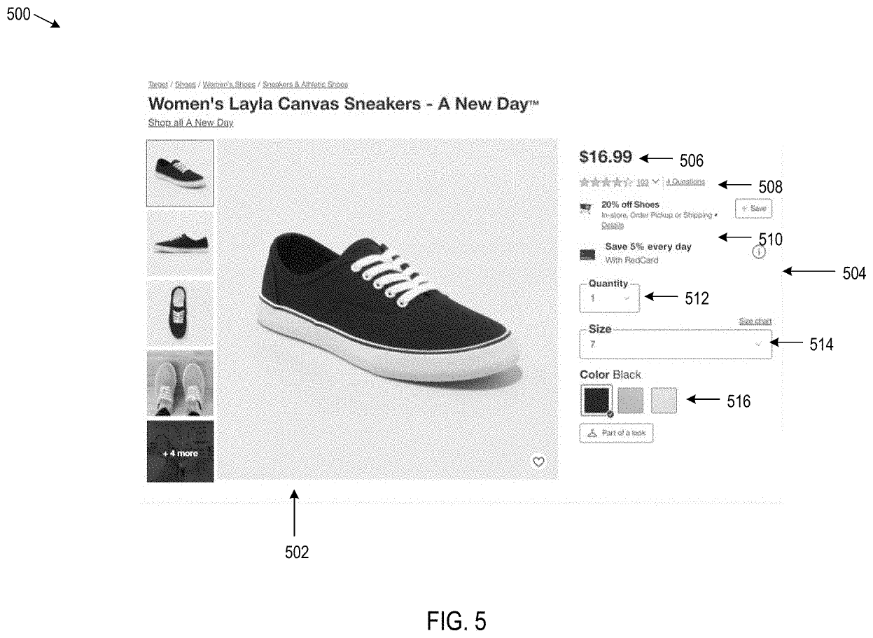

FIG. 5 illustrates another example personalized user interface display 500 associated with the enterprise webpage or application 112. The example personalized user interface display 500 is configured to display a product details page.

In some examples, the product details page displayed on the example personalized user interface display 500 includes a product images section 502 and a product details section 504. In some examples, the product images section 502 displays one or more images associated with the selected product listing. In other examples, the product details section 504 may list detailed information regarding the selected product listing.

In some examples, the product details section 504 may include a price section 506 that lists the current price of the selected product, a rating and reviews section 508 that lists an average customer rating and a link to one or more customer reviews associated with the selected product, a deals section 510 that includes one or more deals associated with the selected product, a selectable quantity option 512 that allows the user to select the quantity of the selected product that the user wishes to purchase, a selected size option 514 that allows the user to select the user's size associated with the selected product and a selectable color/style option 516 that allows to select the color of style of the selected product. In other examples, the product details section 504 may include more or fewer sections and options.

In the disclosed example, the selectable quantity option 512, the selectable size option 514 and the selectable color/style option 516 allow the user to select from a plurality of options in order to customize the product and order according to the user's preferences. In the disclosed personalized user interface 500, based on predictions made by the preference predictor sub-module 206, the disclosed personalization sub-module 208 of the context-based personalization system 100 may alter the default setting of the selectable options 512, 514 and 516 to a setting that is aligned with the particular user's preferences. In other words, typically, the selectable size option 514 may by default be set to blank. However, the disclosed context-based personalization system 100 causes the default setting to be altered from blank to size 7 based on the prediction that the user typically purchases size 7 shoes.

In other examples, similar alterations to default settings can be made to other selection options as well. For example, a user purchasing groceries may search for bananas and find that the selectable quantity option is already set to “5,” the number of bananas the user typically purchases. In some examples, such personalization of user selectable settings makes it easier and faster for the user to make a purchase and increases the user engagement and conversion rates.

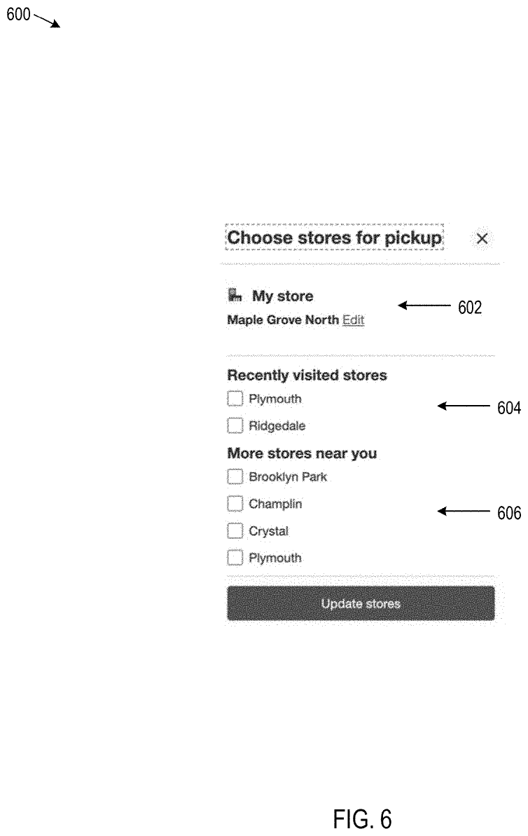

FIG. 6 illustrates another example personalized user interface display 600 associated with the enterprise webpage or application 112. The example personalized user interface display 600 is configured to display personalized options for product pickup location.

In some examples, during the purchase of one or more products from the enterprise using an online platform, the user may be presented with a user interface display requesting the user's input on the which of a plurality of physical store locations the user would like to pickup the purchased products from. In the disclosed example from FIG. 6, the personalized user interface display 600 is configured to include a default “my store” option 602 that lists the store that is set as the default option for product pickup.

In some examples, in addition to the default “my store” option 602, based on the predictions made by the preference predictor sub-module 206, the personalization sub-module 208 may cause the personalized user interface 600 to display addition options, including a “recently visited stores” option 604 and a “more stores near you” option 606. For example, the based on recent user events where the user selected a different store for product pickup than the default store, the personalization sub-module 208 may cause the “recently visited stores” option 604 to display other stores that the user may prefer to pickup products from.

In the disclosed example from FIG. 6, the user has included “Maple Grove North” as the default store from which the user typically picks up products from. However, the user may have in the recent past also selected the “Plymouth” and the “Ridgedale” stores for product pick up as well. Based on these user events, the personalization sub-module 208 lists the Plymouth and Ridgedale locations under the “recently visited stores” option 604.

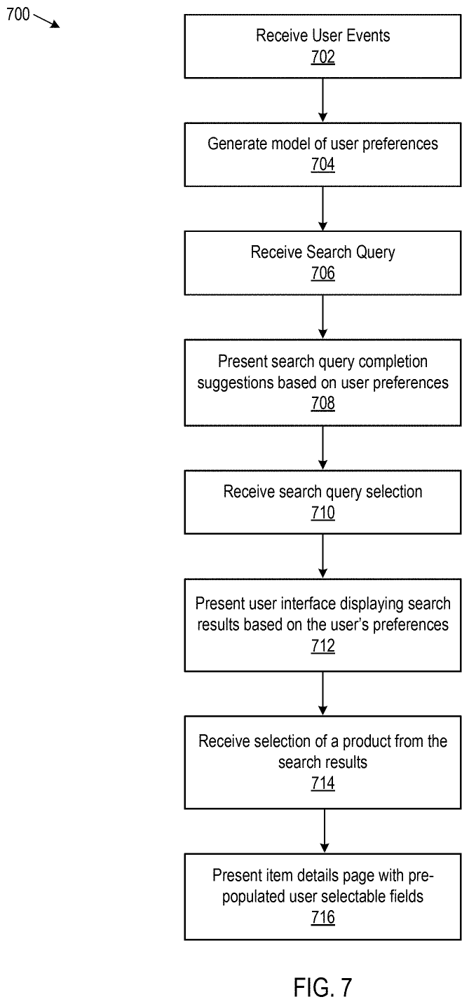

FIG. 7 illustrates a flowchart 700 of an example set of steps executed by the context-based personalization module 108.

In example operation 702, the context-based personalization module 108 receives user events. In some examples, the event handler sub-module 202 may receive a stream of user events in real time. In other examples, the event handler sub-module 202 may receive the user events after a time delay. The user events may include any action the user performs in interfacing with the enterprise application 112. For example, user events may include clicks, swipes, toggles, typed texts, search query terms, selection of user options, adds to cart, products or services purchased, browsing pattern, etc.

In some examples, all user events are received and collected by the event handler sub-module 202 during operation 702. In other examples, only certain types of user events are collected by the event handler sub-module 202.

In example operation 704, the context-analyzer sub-module 204 and the preference predictor sub-module 206 of the context-based personalization module 108 analyzes the received and/or collected user events from operation 702 to identify and extract user affinity signals that are included within the user events, and use a machine learning data model to analyze the extracted user affinity signals and the stored user events to generate a model of user preferences. For example, the generated user preferences can be a prediction of user preferences regarding one or more user options associated with the enterprise's webpage or application 112.

In example operation 706, the context-based personalization module 108 may receive a search query from the user. For example, the user may type a search query using the user interface of the enterprise application 112. The search query can include one or more words describing a product of service offered by the enterprise and listed within the application 112.

In example operation 708, in response to receiving a search query, the context-based personalization module 108 presents one or more search query term auto-complete suggestions based on the user's predicted preferences. For example, the personalization sub-module 208 analyzes the search query terms received in operation 706 using the user preferences model generated in example operation 704 and presents one or more search query auto-complete options that are based on the user's predicted preferences. As described in relation to FIG. 3, in some examples, the one or more search query auto-complete options may be presented for selection by the user in a drop-down menu associated with a search query box on the user interface of the enterprise application 112. In other example user interface, other ways of presenting the search query auto-complete options for user selection is also possible.

In example operation 710, context-based personalization module 108 receives the search query terms selected by the user from example operation 708. In some examples, the user may select one of the search query auto-complete options presented in example operation 708. In other examples, the user may simply enter the search query terms typed in without selecting any of the presented auto-complete options. In the disclosed example operation 710, the entered search query terms are received by the context-based personalization module 108 and used to search for products and service offered by the enterprise that are relevant to the entered search query terms.

In example operation 712, the context-based personalization module 108 presents a user interface display on the enterprise application 112 that displays the search results associated with the search query terms received from operation 710 and based on the user's preferences. As described in relation to FIG. 4, the personalization sub-module 208 re-orders search results associated with search query terms such that search results that are more relevant to the user are elevated to the top of the search query results. For example, out of search results associated with received search queries, one or more products or service that are predicted to be more relevant to the user based on the generated user preference model from operation 704 is presented at the top of the search results.

In example operation 714, the context-based personalization module 108 may receive a selection of a product or service from among the search results presented in example operation 712. For example, as previously described in relation to operation 712, the search results, including products and/or services associated with the search query terms are presented on the user interface of the enterprise application 112. The user may make a selection of one such product or service that is relevant to the user's search query. The context-based personalization module 108 receives the user selection of a search result.

In example operation 716, the personalization sub-module 208 of the context-based personalization module 108 analyzes the received product or service selection and applies user selections according to the predicted preferences to any user-selectable fields. For example, the user selectable fields within a product or service details user interface display of the enterprise application 112 can be pre-populated based on what is predicted to be the user's preferences by the user preferences model generated in operation 704. For example, some user-selectable fields that may be pre-populated based on predicted user preferences may include size, color, style, quantity, brand, shipping information, payment information, delivery information, pick-up information, etc.

By using the user preferences model to present search query auto-complete option in operation 708, present re-ordered search query results in operation 712 and present pre-populated user-selectable option in operation 716, the context-based personalization module 108 provides a practical application by increasing computing efficiency. For example, the computing system need to expend resources in presenting results/options to the user that are not relevant and interfacing with a user in effecting a transaction. The disclosed system 100 presents more relevant, interesting results that requires fewer clicks from the user to select the necessary parameters to order items. Thus, the disclosed system 100 may receive more engagement from the user and ultimately improve the field of online commerce.

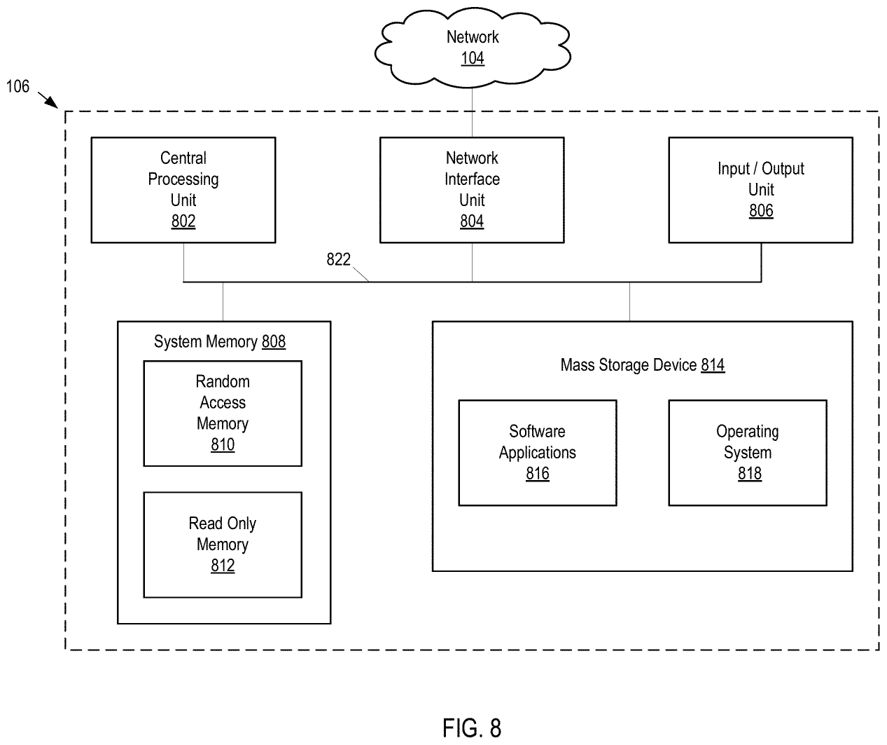

FIG. 8 illustrates example physical components of the computing devices of FIG. 1. As illustrated in the example of FIG. 8, the server computer 106 includes at least one central processing unit (“CPU”) 802, a system memory 808, and a system bus 822 that couples the system memory 808 to the CPU 802. The system memory 808 includes a random-access memory (“RAM”) 810 and a read-only memory (“ROM”) 812. A basic input/output system that contains the basic routines that help to transfer information between elements within the server computer 106, such as during startup, is stored in the ROM 812. The server computer 106 further includes a mass storage device 814. The mass storage device 814 is able to store software instructions and data 816 associated with software applications 816. Some or all of the components of the server computer 106 can also be included in user electronic computing device 102.

The mass storage device 814 is connected to the CPU 802 through a mass storage controller (not shown) connected to the system bus 822. The mass storage device 814 and its associated computer-readable data storage media provide non-volatile, non-transitory storage for the server computer 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 106.

According to various embodiments of the invention, the server computer 106 may operate in a networked environment using logical connections to remote network devices through the network 104, such as a wireless network, the Internet, or another type of network. The server computer 106 may connect to the network 104 through a network interface unit 804 connected to the system bus 822. It should be appreciated that the network interface unit 804 may also be utilized to connect to other types of networks and remote computing systems. The server computer 106 also includes an input/output controller 806 for receiving and processing input from a number of other devices, including a touch user interface display screen, or another type of input device. Similarly, the input/output controller 606 may provide output to a touch user interface display screen or other type of output device.

As mentioned briefly above, the mass storage device 814 and the RAM 810 of the server computer 106 can store software instructions and data associated with software applications 816. The software instructions include an operating system 818 suitable for controlling the operation of the server computer 106. The mass storage device 814 and/or the RAM 810 also store software instructions, that when executed by the CPU 802, cause the server computer 106 to provide the functionality of the server computer 106 discussed in this document. For example, the mass storage device 814 and/or the RAM 810 can store software instructions that, when executed by the CPU 802, cause the server computer 106 to display received data on the display screen of the server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of personalizing options on an enterprise application for a user, the method comprising:
receiving a plurality of user events associated with one or more user sessions, wherein each of the one or more user sessions includes a discrete period of time when the user is interfacing with the enterprise application;
extracting user affinity signals from the plurality of user events;
based on the plurality of user events and user affinity signals, predicting the user's preferences associated with one or more options associated with the enterprise application;
personalizing the one or more options associated with the enterprise application to align with the user's preferences, including:
reordering product listings such that one or more products including a feature that is predicted to be aligned with the user's preference is elevated to the top of the product listings, wherein the feature is one of: size, color, brand, price, gender and type.

2. The method of claim 1, wherein personalizing the one or more options further includes reordering search query auto-complete options such that a search query auto-complete option that is predicted to be aligned with the user's preference is elevated to the top of the search query auto-complete options.

3. The method of claim 1, wherein personalizing the one or more options further includes reordering one or more filter facets within a filter facet option such that a filter facet that is predicted to be aligned with the user's preference is elevated to the top of the filter facet option.

4. The method of claim 1, wherein personalizing the one or more options further includes displaying a personalized filter facet with one or more options, wherein each of the one or more options is predicted to be aligned with the user's preferences.

5. The method of claim 1, wherein the enterprise is an online retailer of at least one of products and services.

6. The method of claim 1, further comprising:
storing the plurality of user events and the user affinity signals associated with each of the one or more user sessions in one or more datastores.

7. The method of claim 1, wherein the each of the plurality of user events includes an action the user performs in interfacing with the enterprise application.

8. The method of claim 7, wherein each of the plurality of user event includes one of: clicks, swipes, toggles, typed texts, search query terms, selection of user options, adds to cart, products or services purchased, and browsing pattern.

9. The method of claim 1, wherein the user affinity signals are inferences made about the user and the user's preferences based on an analysis of the user events, wherein the analysis of the user events includes the extraction of previous selections made by the user on the enterprise application.

10. The method of claim 9, wherein the user affinity signals includes one or more of: clothing size, shoe size, age, gender, dietary preferences, brand preferences, style preferences, price sensitivity, gifting preferences, fulfillment affinity, preferences for trends, store trip history, payment preferences, pickup preferences and delivery preferences.

11. A system for personalizing options on an enterprise application for a user, the system comprising:
a processor;
memory storing instructions that when executed by the processor cause the system to:
receive a plurality of user events associated with one or more user sessions, wherein each of the one or more user sessions includes a discrete period of time when the user is interfacing with the enterprise application;
extract user affinity signals from the plurality of user events;
based on the plurality of user events and user affinity signals, predict the user's preferences associated with one or more options associated with the enterprise application;
personalize the one or more options associated with the enterprise application to align with the user's preferences, including:
reorder of product listings such that one or more products including a feature that is predicted to be aligned with the user's preference is elevated to the top of the product listings, wherein the feature is one of: size, color, brand, price, gender and type.

12. The system of claim 11, wherein personalize the one or more options further includes reorder search query auto-complete options such that a search query auto-complete option that is predicted to be aligned with the user's preference is elevated to the top of the search query auto-complete options

13. The system of claim 11, wherein personalize the one or more options further includes reorder of one or more filter facets within a filter facet option such that a filter facet that is predicted to be aligned with the user's preference is elevated to the top of the filter facet option.

14. The system of claim 11, wherein personalize the one or more options further includes display of a personalized filter facet with one or more options, wherein each of the one or more options is predicted to be aligned with the user's preferences.

15. The system of claim 11, wherein the instructions when executed by the process further cause the processor to:
store the plurality of user events and the user affinity signals associated with each of the one or more user sessions in one or more datastores.

16. The system of claim 11, wherein the each of the plurality of user events includes an action the user performs in interfacing with the enterprise application.

17. The system of claim 16, wherein each of the plurality of user event includes one of: clicks, swipes, toggles, typed texts, search query terms, selection of user options, adds to cart, products or services purchased, and browsing pattern.

18. The system of claim 11, wherein the user affinity signals are inferences made about the user and the user's preferences based on an analysis of the user events, wherein the analysis of the user events includes the extraction of previous selections made by the user on the enterprise application.

19. The system of claim 18, wherein the user affinity signals includes one or more of: clothing size, shoe size, age, gender, dietary preferences, brand preferences, style preferences, price sensitivity, gifting preferences, fulfillment affinity, preferences for trends, store trip history, payment preferences, pickup preferences and delivery preferences.

20. A method of personalizing an enterprise application for a user, the method comprising:
receiving a plurality of user events associated with one or more user sessions, wherein each of the one or more user sessions includes a discrete period of time when the user is interfacing with the enterprise application;
extracting user affinity signals from the plurality of user events;
based on the plurality of user events and user affinity signals, generating a user preference model that predicts the user's preferences regarding one or more options associated with the enterprise application;
receiving one or more search query terms;
presenting one or more search query completion options associated with the received one or more search query terms based on the generated user preference model;
receiving a selection of a search query completion option from the on or more search query completion options;
presenting one or more search result options associated with the selected search query completion option, wherein the presented search result options are re-ordered based on the user preference model and the presented search result options include one or more items;
receiving a selection of an item from the one or more search result options; and
presenting an item details user interface display associated with the enterprise application, wherein the item details user interface display includes one or more pre-populated user selectable options associated with the selected item.
